(19) United States
(12) Patent Application Publication
(10) Pub. No.: US 2022/0268304 A1
(43) Pub. Date: Aug. 25, 2022

(54) COMPONENT MOUNTING STRUCTURE OF VEHICLE BODY

(71) Applicant: TOYOTA JIDOSHA KABUSHIKI KAISHA, Toyota-shi Aichei-ken (JP)

(72) Inventors: Naoya Hirayama, Nagoya-shi Aichi-ken (JP); Tetsuro Enomoto, Toyota-shi Aichi-ken (JP)

(21) Appl. No.: 17/677,187

(22) Filed: Feb. 22, 2022

(30) Foreign Application Priority Data
Feb. 24, 2021 (JP) 2021-027590

(51) Int. Cl. F16B 5/07

(52) U.S. Cl. CPC F16B 5/07

(57) ABSTRACT

A cover flange portion is tightly held in a first groove portion by an upper hook portion and first upper ribs formed on both sides of the upper hook portion along the longitudinal direction of the upper hook portion, and a bumper flange portion is tightly held in a second groove portion by a lower hook portion and second upper ribs formed on both sides of the lower hook portion along the longitudinal direction of the lower hook portion.

### CROSS REFERENCE TO RELATED APPLICATION

This application claims priority to Japanese Patent Application No. 2021-027590 filed on Feb. 24, 2021, which is incorporated herein by reference in its entirety including the specification, claims, drawings, and abstract.

### TECHNICAL FIELD

The present disclosure relates to a component mounting structure for mounting a first component and a second component together to a retaining portion provided in a vehicle body.

### BACKGROUND

A vehicle body of a vehicle is provided with a retaining portion (retainer) to which components are mounted and which retains those components. For example, in a structure where a bumper is mounted to a retainer, the bumper is mounted to the retainer by engaging a hook portion of the bumper with a hook portion of the retainer (for example, see JP 2008-296845 A).

The backside of the bumper of the vehicle is provided with an electromagnetic wave sensor constituting a driver assistance system. Along with expansion of the driver assistance system of the vehicle, the specifications of the electromagnetic wave sensor may be changed. For example, when a frequency range of radio waves of the electromagnetic wave sensor is changed to a higher region, radio wave transmission performance may change depending on the thickness of the bumper and the thickness of a coating film. It is thus necessary to control the thickness of the bumper and the coating film to be within a predetermined thickness.

However, the bumper is a large component extending along the vehicle width direction, and therefore, it is impossible to control the thickness of the bumper and the coating film to be within a predetermined thickness. To enable such control, the electromagnetic wave sensor described above is covered with a sensor cover, apart from the bumper. The sensor cover is a component smaller than the bumper, and thus, by using it, it becomes easier to control the thickness of the bumper and the coating film to be within a predetermined thickness.

### CITATION LIST

### PATENT DOCUMENT 1: JP 2008-296845 A

### SUMMARY

However, when the bumper and the sensor cover are mounted to the vehicle body, the retainer needs to have an additional mounting structure for mounting the sensor cover thereto. The mounting structure has a complicated shape, and therefore, it is often molded with a mold. Providing the additional mounting structure thus results in increase in the mold processing cost.

An object of the present disclosure is providing a component mounting structure that allows two different components to be mounted together to a retaining portion provided in a vehicle body.

A component mounting structure according to the present disclosure is a component mounting structure for mounting a first component and a second component to a retaining portion provided in a vehicle body. In this structure, the retaining portion includes a protruding portion formed to protrude, from a bottom of a groove portion formed in the retaining portion, along the depth direction of the groove portion. The groove portion is composed of a first groove portion formed above the protruding portion in the groove portion and a second portion formed below the protruding portion in the groove portion. The first component includes a first flange portion to be inserted into the first groove portion, and the second component includes a second flange portion to be inserted into the second groove portion. An upper hook portion formed on the upper side of a tip end portion of the protruding portion and a first hook portion formed on a tip end portion of the first flange portion engage with each other, and a lower hook portion formed on the lower side of the tip end portion of the protruding portion and a second hook portion formed on a tip end portion of the second flange portion engage with each other. The first flange portion is tightly held in the first groove portion by the upper hook portion and first ribs formed on both sides of the upper hook portion along the longitudinal direction of the upper hook portion, and the second flange portion is tightly held in the second groove portion by the lower hook portion and second ribs formed on both sides of the lower hook portion along the longitudinal direction of the lower hook portion.

In the component mounting structure according to some embodiments of the present disclosure, the protruding portion has a notch formed on a base end side of the upper hook portion and the lower hook portion in the depth direction of the groove portion.

The component mounting structure according to the present disclosure allows the two different components to be mounted together to the retaining portion provided in the vehicle body. The single component mounting structure can thus function as two component mounting structures. Therefore, the mold processing cost can be reduced in the case where the component mounting structure is molded with a mold.

### BRIEF DESCRIPTION OF DRAWINGS

An embodiment of the present disclosure will be described based on the following figures, wherein:

FIG. 1 is a perspective view showing a rear part of a vehicle body according to an embodiment;

FIG. 2 is a perspective view showing a retainer according to an exemplified embodiment;

FIG. 3 is a detailed view of Part A in FIG. 2;

FIG. 4 is a perspective view showing the backside of a sensor cover and a bumper according to the exemplified embodiment;

FIG. 5 is a detailed view of Part B in FIG. 4; and

FIG. 6 is a cross sectional view corresponding to a cross section along C-C in FIG. 3 and a cross section along D-D in FIG. 5, where the sensor cover and the bumper are mounted to the retainer.

### DESCRIPTION OF EMBODIMENT

An exemplified embodiment of the present disclosure will be described in detail hereinafter. In the description below, specific shapes, materials, directions, numerical values, etc. are provided as illustrations for facilitating the understanding of the present disclosure, and can be appropriately changed according to applications, purposes, specifications, and the like.

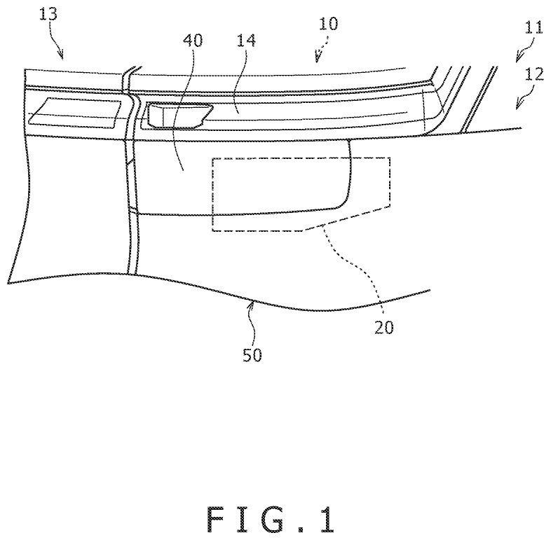

A rear part of a vehicle 11 according to the embodiment will be described with reference to FIG. 1. FIG. 1 is a perspective view showing the rear part of the vehicle 11.

A component mounting structure 10 is a structure for mounting a sensor cover 40 as a first component and a bumper 50 as a second component to a retainer 20 which is a retaining portion provided in the rear part of a vehicle body 12 of the vehicle 11 as described below.

The component mounting structure 10 allows the sensor cover 40 and the bumper 50 to be mounted together to the retainer 20 in a manner described in detail below. The single component mounting structure 10 can thus function as two component mounting structures. Therefore, the mold processing cost can be reduced in the case where the component mounting structure 10 is molded with a mold. The component mounting structure 10 also allows the sensor cover 40 to be designed small. This enhances the degree of freedom in design of the sensor cover 40.

Although the vehicle 11 of the present example is an engine-driven, four wheel vehicle, it may be a hybrid vehicle or an electric vehicle.

As shown in FIG. 1, the rear part of the vehicle body 12 of the vehicle 11 is provided with a trunk door 13 for opening and closing a trunk, a tail lamp 14 for illuminating the rear of the vehicle 11, the bumper 50 located under the trunk door 13 and the tail lamp 14 and mounted to the retainer 20, and the sensor cover 40 located on an upper end portion of the bumper 50 and mounted to the retainer 20.

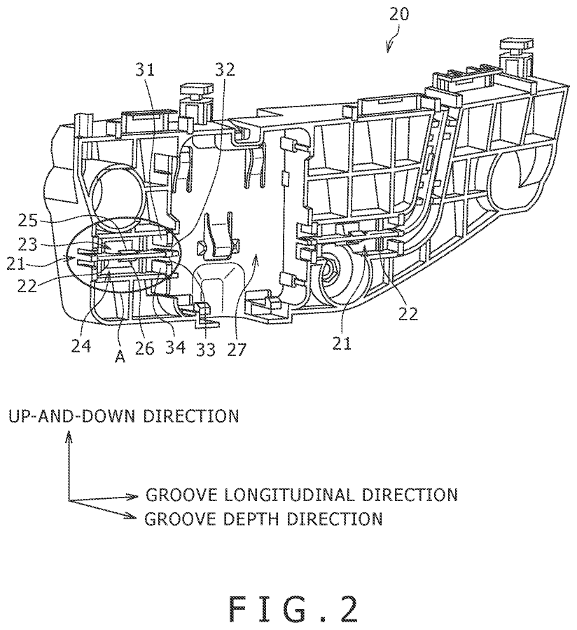

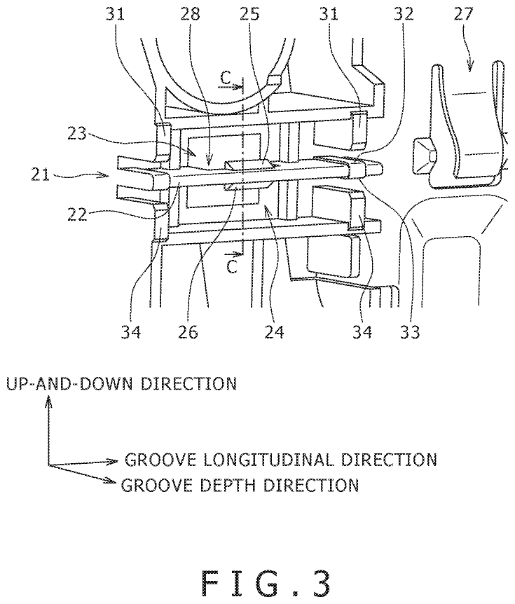

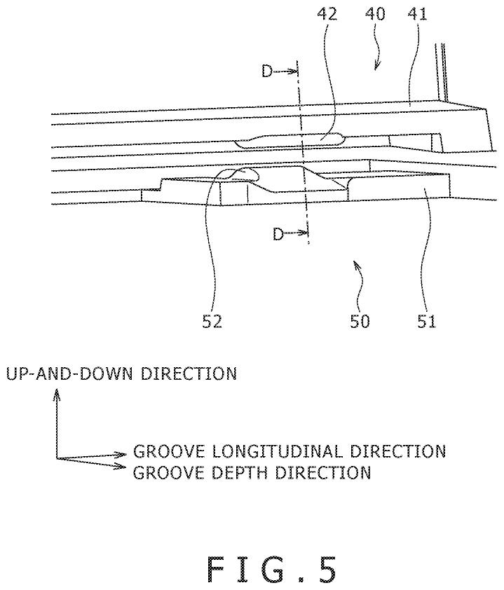

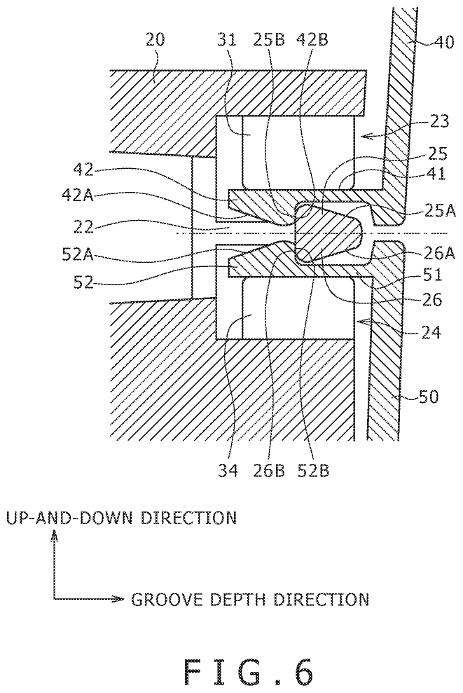

The retainer 20 according to the exemplified embodiment will be described with reference to FIGS. 2, 3, and 6. FIG. 2 is a perspective view showing the retainer 20. FIG. 3 is a detailed view of Part A in FIG. 2. FIG. 6 is a cross sectional view corresponding to a cross section along C-C in FIG. 3 and a cross section along D-D in FIG. 5, where the sensor cover 40 and the bumper 50 are mounted to the retainer 20.

Each of the components will be described hereinafter, assuming that the longitudinal direction of a groove portion 21 in the retainer 20 is the groove longitudinal direction, the short direction of the groove portion 21 is the up-and-down direction, and that the depth direction of the groove portion 21 is the groove depth direction.

As shown in FIG. 2, the retainer 20 is a resin molded component located in the rear part of the vehicle body 12, to which the sensor cover 40 and the bumper 50 are mounted and which retains the sensor cover 40 and the bumper 50. The retainer 20 allows the sensor cover 40 and the bumper 50 to be mounted thereto without using a fixture such as a screw or a bolt and retains the sensor cover 40 and the bumper 50 firmly.

As shown in FIGS. 2 and 3, the retainer 20 includes the groove portion 21 formed in the retainer 20, a protruding portion 22 formed to protrude from a bottom of the groove portion 21 along the groove depth direction, and a sensor mounting portion 27 to which an electromagnetic wave sensor constituting a driver assistance system is mounted.

The groove portion 21 is composed of a first groove portion 23 which is formed above the protruding portion 22 and to which a cover flange portion 41 described below is inserted, and a second groove portion 24 which is formed below the protruding portion 22 and to which a bumper flange portion 51 described below is inserted.

The protruding portion 22 is formed along the longitudinal direction of the groove portion 21, and the length of the protruding portion 22 in the groove depth direction is approximately the same as the length of the groove portion 21 in the groove depth direction (depth of the groove portion 21). The protruding portion 22 includes an upper hook portion 25 formed on the upper side of a tip end portion of the protruding portion 22 and a lower hook portion 26 formed on the lower side of the tip end portion of the protruding portion 22.

The upper hook portion 25 is a portion for engaging with a cover hook portion 42 of the sensor cover 40 described below. The upper hook portion 25 engages with the cover hook portion 42, thereby firmly retaining the sensor cover 40 in the groove depth direction. In other words, it can prevent the sensor cover 40 from falling off in the insertion direction.

The upper hook portion 25, together with two first upper ribs 31 described below, also tightly hold the cover flange portion 41, thereby firmly retaining the cover flange portion 41 inserted into the first groove portion 23.

As shown in FIG. 6, when viewed from the groove longitudinal direction, the upper hook portion 25 includes an inclined portion 25A formed to incline upward and inward from its tip end side in the groove depth direction, and an engagement portion 25B formed as a wall extending in the up-and-down direction.

The lower hook portion 26 is a portion for engaging with a bumper hook portion 52 of the bumper 50 described below. The lower hook portion 26 engages with the bumper hook portion 52, thereby firmly retaining the bumper 50 in the groove depth direction. In other words, it can prevent the bumper 50 from falling off in the insertion direction.

The lower hook portion 26, together with two second lower ribs 34 described below, also tightly hold the bumper flange portion 51, thereby firmly retaining the bumper flange portion 51 inserted into the second groove portion 24.

As shown in FIG. 6, when viewed from the groove longitudinal direction, the lower hook portion 26 includes an inclined portion 26A formed to incline downward and inward from its tip end side in the groove depth direction, and an engagement portion 26B formed as a wall extending in the up-and-down direction.

The protruding portion 22 has a notch 28 formed on a base end side of the upper hook portion 25 and the lower hook portion 26 in the groove depth direction. Thus, when the cover hook portion 42 and the bumper hook portion 52 described below respectively engage with the upper hook portion 25 and the lower hook portion 26, the cover hook portion 42 and the bumper hook portion 52 can be retracted into the notch 28 and prevented from interfering with the protruding portion 22.

As described above, the first groove portion 23 is a portion into which the cover flange portion 41 is inserted. The first groove portion 23 has the first upper ribs 31 formed on an upper wall of the groove portion 21 (upper wall of the first groove portion 23) and first lower ribs 32 formed on an upper surface of the protruding portion 22 (lower wall of the first groove portion 23).

As described above, the first upper ribs 31, together with the upper hook portion 25, tightly hold the cover flange portion 41 inserted into the first groove portion 23, thereby firmly retaining the cover flange portion 41 inserted into the first groove portion 23.

The first lower ribs 32 are ribs that fill a gap between the cover flange portion 41 inserted into the first groove portion 23 and the upper surface of the protruding portion 22 (lower wall of the first groove portion 23), thereby preventing the cover flange portion 41 inserted into the first groove portion 23 from rattling.

In the first groove portion 23, the first upper ribs 31 and the first lower ribs 32 are formed on both sides of the upper hook portion 25 along the groove longitudinal direction. The length of the first upper ribs 31 and the first lower ribs 32 in the groove depth direction is approximately the same as the length of the protruding portion 22 in the groove depth direction.

As described above, the second groove portion 24 is a portion into which the bumper flange portion 51 is inserted. The second groove portion 24 has second upper ribs 33 formed on a lower surface of the protruding portion 22 (upper wall of the second groove portion 24) and second lower ribs 34 formed on a lower wall of the groove portion 21 (lower wall of the second groove portion 24).

The second upper ribs 33 are ribs that fill a gap between the bumper flange portion 51 inserted into the second groove portion 24 and the lower surface of the protruding portion 22 (upper wall of the second groove portion 24), thereby preventing the bumper flange portion 51 inserted into the second groove portion 24 from rattling.

As described above, the second lower ribs 34, together with the lower hook portion 26, tightly hold the bumper flange portion 51 inserted into the second groove portion 24, thereby firmly retaining the bumper flange portion 51 inserted into the second groove portion 24 in the up-and-down direction.

In the second groove portion 24, the second upper ribs 33 and the second lower ribs 34 are formed on both sides of the lower hook portion 26 along the groove longitudinal direction. The length of the second upper ribs 33 and the second lower ribs 34 in the groove depth direction is approximately the same as the length of the protruding portion 22 in the groove depth direction.

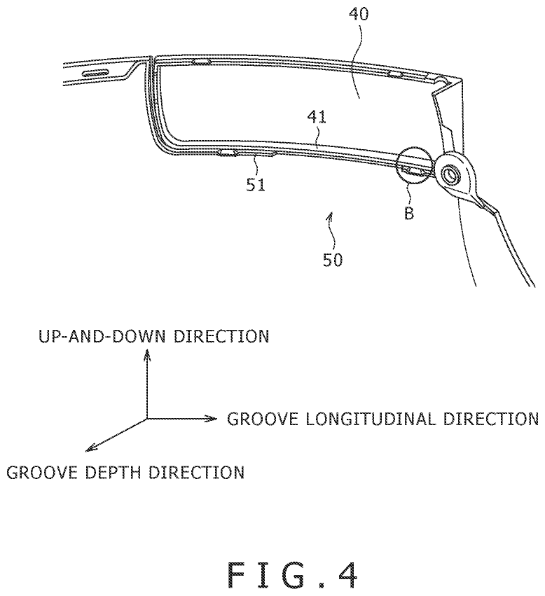

The sensor cover 40 and the bumper 50 according to the exemplified embodiment will be described with reference to FIG. 4 to FIG. 6. FIG. 4 is a perspective view showing the backside of the sensor cover 40 and the bumper 50. FIG. 5 is a detailed view of Part B in FIG. 4.

As shown in FIGS. 4 and 5, the sensor cover 40 is a cover for covering the electromagnetic wave sensor provided in the retainer 20 and is a resin molded component mounted to the retainer 20. The sensor cover 40 includes the cover flange portion 41 as a first flange portion to be inserted into the groove portion 21 of the retainer 20, and the cover hook portion 42 formed on a tip end portion of the cover flange portion 41 as a first hook portion to be engaged with the upper hook portion 25 of the retainer 20.

As described above, the cover flange portion 41 is inserted into the first groove portion 23 of the retainer 20 and protrudes toward the inside of the vehicle body 12 (inside in the groove depth direction in the retainer 20) along an edge of the sensor cover 40 at the boundary with the bumper 50. The cover flange portion 41 is tightly held by the upper hook portion 25 and the two first upper ribs 31, thereby being firmly retained in the retainer 20.

As described above, the cover hook portion 42 is a portion which is formed on the tip end portion of the cover flange portion 41 and engages with the upper hook portion 25 of the retainer 20. The cover hook portion 42 is provided at a position corresponding to the upper hook portion 25 of the retainer 20 in the groove longitudinal direction. As shown in FIG. 6, when viewed from the groove longitudinal direction, the cover hook portion 42 includes an inclined portion 42A formed to incline upward and to a base end side from its tip end side in the groove depth direction, and an engagement portion 42B formed as a wall extending in the up-and-down direction.

As shown in FIGS. 4 and 5, the bumper 50 is a shock absorber for protecting the vehicle body 12 from a light collision and is a resin molded component mounted to the retainer 20. The bumper 50 includes the bumper flange portion 51 as a second flange portion to be inserted into the second groove portion 24 of the retainer 20, and the bumper hook portion 52 formed on a tip end portion of the bumper flange portion 51 as a second hook portion to be engaged with the lower hook portion 26 of the retainer 20.

As described above, the bumper flange portion 51 is inserted into the groove portion 21 of the retainer 20 and protrudes toward the inside of the vehicle body 12 (inside in the groove depth direction in the retainer 20) along an edge of the bumper 50 at the boundary with the sensor cover 40. The bumper flange portion 51 is tightly held by the lower hook portion 26 and the two second lower ribs 34, thereby being firmly retained in the retainer 20.

As described above, the bumper hook portion 52 is a portion which is formed on the tip end portion of the bumper flange portion 51 and engages with the lower hook portion 26 of the retainer 20. The bumper hook portion 52 is provided at a position corresponding to the lower hook portion 26 of the retainer 20 in the groove longitudinal direction. As shown in FIG. 6, when viewed from the groove longitudinal direction, the bumper hook portion 52 includes an inclined portion 52A formed to incline downward and to the base end side from its tip end side in the groove depth direction, and an engagement portion 52B formed as a wall extending in the up-and-down direction.

The manner in which the sensor cover 40 and the bumper 50 are mounted to the retainer 20 will be described with reference to FIG. 6.

As shown in FIG. 6, when the sensor cover 40 and the bumper 50 are mounted to the retainer 20, the engagement portion 25B of the upper hook portion 25 of the retainer 20 engages with the engagement portion 42B of the cover hook portion 42 of the cover flange portion 41 of the sensor cover 40. In addition, the engagement portion 26B of the lower hook portion 26 of the retainer 20 engages with the engagement portion 52B of the bumper hook portion 52 of the bumper flange portion 51 of the bumper 50.

The present disclosure is not limited to the above embodiment and its variations, and, as a matter of course, various modifications and substitutions can be made without departing from the scope of the claims herein.

1. A component mounting structure for mounting a first component and a second component to a retaining portion provided in a vehicle body, wherein
the retaining portion comprises a protruding portion formed to protrude, from a bottom of a groove portion formed in the retaining portion, along a depth direction of the groove portion,
the groove portion is composed of a first groove portion formed above the protruding portion in the groove portion and a second portion formed below the protruding portion in the groove portion,
the first component comprises a first flange portion to be inserted into the first groove portion,
the second component comprises a second flange portion to be inserted into the second groove portion,
an upper hook portion formed on the upper side of a tip end portion of the protruding portion and a first hook portion formed on a tip end portion of the first flange portion engage with each other,
a lower hook portion formed on the lower side of the tip end portion of the protruding portion and a second hook portion formed on a tip end portion of the second flange portion engage with each other,
the first flange portion is tightly held in the first groove portion by the upper hook portion and first ribs formed on both sides of the upper hook portion along a longitudinal direction of the upper hook portion, and
the second flange portion is tightly held in the second groove portion by the lower hook portion and second ribs formed on both sides of the lower hook portion along a longitudinal direction of the lower hook portion.

2. The component mounting structure according to claim 1, wherein the protruding portion has a notch formed on a base end side of the upper hook portion and the lower hook portion in the depth direction of the groove portion.
